(19) United States
(12) Patent Application Publication
(10) Pub. No.: US 2013/0240104 A1
(43) Pub. Date: Sep. 19, 2013

(54) Tire, the Sidewalls of which are Reinforced with a Film of Multiaxially Stretched Thermoplastic Polymer

(71) Applicant: Christophe Le Clerc, Clermont-Ferrand Cedex 9 (FR)

(72) Inventor: Christophe Le Clerc, Clermont-Ferrand Cedex 9 (FR)

(21) Appl. No.: 13/879,268

(22) PCT Filed: Oct. 11, 2011
(86) PCT No.: PCT/EP2011/067732

§ 371 Date: May 30, 2013

(30) Foreign Application Priority Data
Oct. 14, 2010 (FR) 1058365

(51) Int. Cl. B60C 13/00

(52) U.S. Cl. CPC B60C 13/002
USPC 152/525; 152/450

(57) ABSTRACT

Tire comprising a crown surmounted by a tread, two sidewalls, two beads, each sidewall joining each bead to the crown, a carcass reinforcement anchored in each of the beads and extending into the sidewalls and into the crown, a belt extending into the crown circumferentially and located radially between the carcass reinforcement and the tread. At least one of its sidewalls is reinforced by a multiaxially stretched thermoplastic polymer film, positioned between and in contact with two layers of rubber composition, and on the outside with respect to the carcass reinforcement. Preferably, the thermoplastic polymer film has, irrespective of the tensile direction considered, a tensile modulus E which is greater than 500 MPa, a maximum tensile stress σₘₐₓ which is greater than 80 MPa, and an elongation at break Ar greater than 40%.

### FIELD OF THE INVENTION

The present invention relates to vehicle tires and to the reinforcing thereof. It relates more particularly to the use of polymer films and multilayer laminates in the sidewalls of such tires, especially as layers for protecting against various attacks or perforations.

### PRIOR ART

As is well known, a vehicle tire comprises a crown surmounted radially on the outside by a tread, two beads intended to cooperate with a mounting rim, two flexible sidewalls, each sidewall joining a bead to the crown, a carcass reinforcement anchored in each of the beads and extending into the sidewalls and into the crown, a rigid crown reinforcement or “belt” extending into the crown circumferentially and located radially between the carcass reinforcement and the tread, this tire delimiting, with the mounting rim, a cavity in which the inflation pressure is usually applied.

Each lateral wall of the tire located between the crown and the bead is commonly referred to as a sidewall. Each sidewall basically consists of at least the above carcass reinforcement, reinforced by textile or metal reinforcing threads, (oriented radially in the case of a radial carcass), this reinforcement being surrounded by an outer (with respect to the carcass reinforcement) sidewall layer also referred to as “outer part of the sidewall” (portion of the sidewall that is visible from the outside once the tire is mounted on its rim) and by an inner (with respect to the carcass reinforcement) sidewall layer also referred to as “inner part of the sidewall” (portion of the sidewall on the side of the cavity, i.e. that is not visible from the outside once the tire is mounted on its rim), it being possible for this inner part of the sidewall to be formed simply by the inner liner that customarily defines the radially inner face of a tire.

Several other rubber layers, which may or may not be reinforced by reinforcing threads, may be added, where necessary, to this base structure in order to reinforce these flexible sidewalls. In particular, depending on the requirements, these sidewalls may comprise one or more protective plies, located on the outside with respect to the carcass reinforcement, the role of which protective plies is to protect the rest of the structure of the sidewall from external attacks, impacts, tearing or other perforations. This is, for example, the case in the sidewalls of certain tires intended for rolling over relatively rough ground, for example on rally-type passenger vehicles or else on industrial off-road vehicles of the construction site type.

These protective plies must be sufficiently flexible and deformable so as, on the one hand, to follow as closely as possible the shape of the obstacle on which the sidewall is liable to bear during rolling and, on the other hand, to prevent the possible penetration of foreign bodies towards the inside of said sidewall. To meet such criteria generally requires the use, in these protective plies or layers, of reinforcing threads in the form of elastic metal-strand cords combining a high elasticity and a high energy at break.

Such metallic protective plies for tire sidewalls are well known, they have been described, for example, in patents or patent applications FR 1 502 689 (or U.S. Pat. No. 3,464,477), EP 1 270 273 (or US 2003/0005993).

However, they have a certain number of drawbacks. Besides the fact that they consequently make the tire sidewalls heavier, they are formed from strand cords that are relatively expensive, this being so on two counts: firstly, they are prepared in two steps, namely by the prior manufacture of the strands followed by assembly by twisting these strands, and, secondly, they generally require their threads to have a high twist (i.e. a very short helix pitch), this twist certainly being essential in order to give them the desired elasticity but leading to reduced manufacturing rates. This drawback of course has repercussions on the cost of the tires themselves.

Other known drawbacks of these metal cords are their sensitivity to corrosion, their weight and their relatively large size (outside diameter).

### BRIEF DESCRIPTION OF THE INVENTION

By continuing their research, the Applicants have found a light and high-performance material that makes it possible in particular to replace these conventional plies reinforced with elastic steel cords and therefore to overcome the aforementioned drawbacks.

Thus, according to a first subject matter, the present invention relates to a tire comprising a crown surmounted by a tread, two sidewalls, two beads, each sidewall joining each bead to the crown, a carcass reinforcement anchored in each of the beads and extending into the sidewalls and into the crown, a belt extending into the crown circumferentially and located radially between the carcass reinforcement and the tread, this tire being characterized in that at least one of its sidewalls is reinforced by a multiaxially stretched thermoplastic polymer film, positioned between and in contact with two layers of rubber composition, and located on the outside with respect to the carcass reinforcement.

Thus positioned, between and in contact with two layers of rubber composition, the thermoplastic polymer film above forms, with these two adjacent layers, a multilayer laminate that has a flexible and highly deformable structure, which structure has unexpectedly proved to exhibit a high resistance to perforation forces, equivalent to that of conventional fabrics reinforced for example with metal cords, despite a substantially smaller thickness.

Owing in particular to its reduced thickness, this laminate also has the advantage of having a low hysteresis in comparison with conventional protective fabrics or plies. A major objective of tire manufacturers is precisely to lower the hysteresis of the tire constituents in order to reduce the rolling resistance of these tires.

The tires of the invention may be intended for motor vehicles of the passenger, 4×4 and SUV (Sport Utility Vehicle) type, but also for two-wheel vehicles, such as motorcycles or bicycles, or for industrial vehicles chosen from vans, “heavy” vehicles—i.e., underground trains, buses, heavy road transport vehicles (lorries, towing vehicles, trailers), off-road vehicles, agricultural or civil engineering machines, aircraft and other transport or handling vehicles.

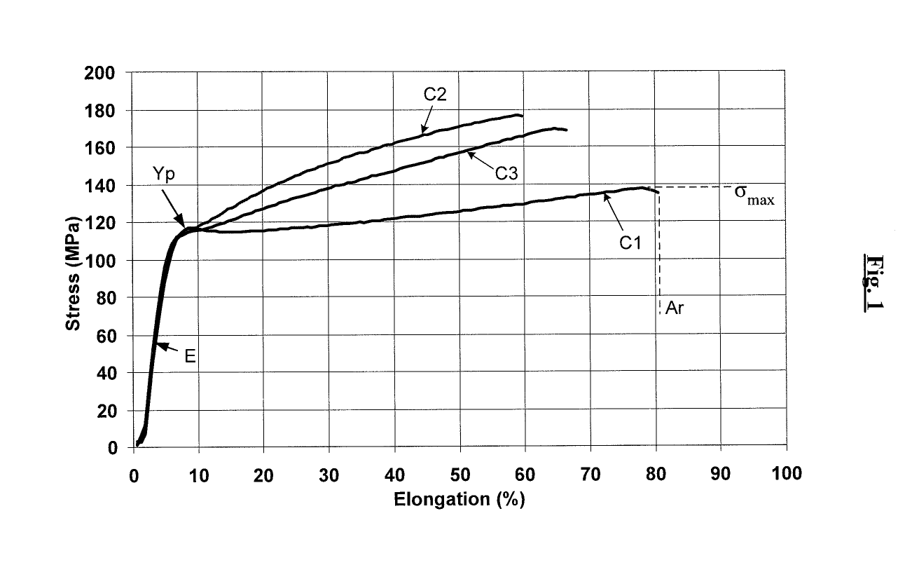

The invention and its advantages will be readily understood in the light of the detailed description and exemplary embodiments that follow, and also FIGS. 1 to 3 relating to these embodiments, which show schematically (unless otherwise indicated, not to a specific scale):

stress-elongation curves recorded, in three tensile directions, on a multiaxially oriented thermoplastic polymer (PET) film that can be used in the tire of the invention (FIG. 1);

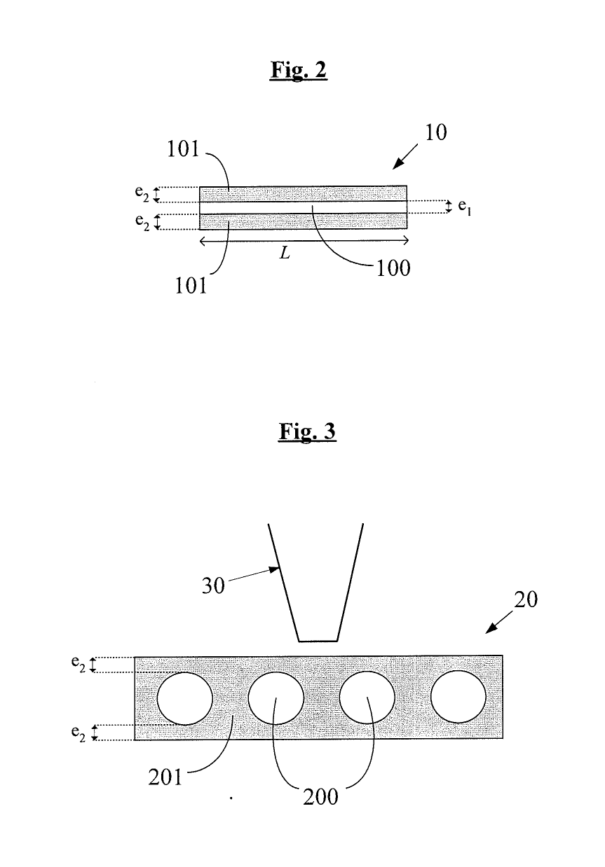

in cross section, a thermoplastic polymer film and a multilayer laminate that can be used in accordance with the invention (FIG. 2);

in cross section, a conventional protective ply comprising high-elongation metal cords (FIG. 3).

### DEFINITIONS

In the present application, the following definitions are adopted:
“axial”: a direction parallel to the axis of rotation of the tire; this direction may be “axially interior” when it is oriented towards the inside of the tire and “axially exterior” when it is oriented towards the outside of the tire;
“bead”: the relatively inextensible portion of the tire internally radially adjacent to the sidewall and the base of which is intended to be mounted on a rim seat of a vehicle wheel;
“rubber” or “elastomer” (the two terms being considered to be synonymous): any type of diene or non-diene, for example thermoplastic, elastomer;
“diene rubber”: any elastomer (single elastomer or mixture of elastomers) that results, at least in part (i.e., a homopolymer or a copolymer), from diene monomers, i.e. from monomers bearing two carbon-carbon double bonds, whether the latter are or are not conjugated;
“layer”: a strip or any other three-dimensional element having a relatively small thickness with respect to its other dimensions, for which the ratio of the thickness to the largest of the other dimensions is less than 0.5, preferably less than 0.1;
“sidewall”: the portion of the tire, usually of low flexural stiffness, located between the crown and the bead;
“sheet” or “film”: any thin layer for which the ratio of the thickness to the smallest of the other dimensions is less than 0.1;
“reinforcing thread”: any long thin strand, any elementary filament, any multifilament fibre or any assembly of such filaments or fibres such as folded yarns or cords, having a long length relative to its cross section, capable of strengthening the tensile properties of a rubber matrix, this thread possibly being straight or non-straight, for example twisted, or crimped;
“phr”: parts by weight per hundred parts of elastomer or rubber;
“radial”: a direction that passes through the axis of rotation of the tire and normal to the latter; this direction may be “radially interior (or inner)” or “radially exterior (or outer)” depending on whether it is oriented towards the axis of rotation of the tire or towards the outside of the tire;
“laminate” or “multilayer laminate”: within the meaning of the International Patent Classification, any product comprising at least two layers, of flat or non-flat form, which are in contact with one another, the latter possibly or possibly not being joined or connected together; the expression “joined” or “connected” should be interpreted broadly so as to include all means of joining or assembling, in particular via adhesive bonding.

Moreover, unless expressly indicated otherwise, all the percentages (%) shown are % by weight.

Any range of values denoted by the expression “between a and b” represents the field of values ranging from more than a to less than b (that is to say limits a and b excluded) whereas any range of values denoted by the expression “from a to b” means the field of values ranging from a up to b (that is to say including the strict limits a and b).

In the present application, by definition, an element A is said to be “inner” or “located on the inside” with respect to the carcass reinforcement if it is positioned, with respect to the latter, on the side of the inflation cavity of the tire. Conversely, an element B is said to be “outer” or “located on the outside” with respect to the carcass reinforcement if it is positioned, with respect to the latter, on the other side.

### DETAILED DESCRIPTION OF THE INVENTION

The tire of the invention therefore has the essential feature that at least one of its sidewalls (i.e. only one sidewall or both) is reinforced by a multiaxially stretched thermoplastic polymer film, this film being positioned between and in contact with two layers of rubber composition, thus forming an assembly described in the present application as a “multilayer laminate”; said film, layers and laminate are described in detail below.

Any thermoplastic polymer film that is multiaxially stretched in its plane, that is to say stretched or oriented in more than one direction in the plane of the film, can be used. Such multiaxially stretched films are well known, used mainly to date in the packaging industry, the food industry, in the electrical field or else as a support for magnetic coatings.

They are prepared according to various well-known stretching techniques, all intended to give the film good mechanical properties in several main directions rather than in a single direction as is the case for standard thermoplastic polymer films or fibres (for example PET or nylon films or fibres) which are, in a known manner, uniaxially stretched (stretched in a single direction) during the melt spinning thereof or extrusion thereof. Such conventional films that are uniaxially stretched and that consequently do not have good mechanical properties irrespective of the tensile direction considered, and in particular their application as inner liners or stiffening layers in tires, have for example been described in patent applications JP 6-211008, JP 10-035231, EP 2 123 480 (or US 2009/283194).

Such techniques require multiple stretching operations in several directions, longitudinal stretching, transverse stretching and planar stretching operations in the plane of the film. By way of example, mention may especially be made of the biaxial stretch-blow moulding technique. The stretching operations may be carried out in one or more stages; when there are several stretching operations these may be simultaneous or sequential. The draw ratio or ratios applied, generally greater than 2, are a function of the targeted final mechanical properties.

Multiaxially stretched thermoplastic polymer films and also the methods for obtaining them have been described in numerous patent documents, for example in documents FR 2539349 (or GB 2134442), DE 3621205, EP 229346 (or U.S. Pat. No. 4,876,137), EP 279611 (or U.S. Pat. No. 4,867,937), EP 539302 (or U.S. Pat. No. 5,409,657) and WO 2005/011978 (or US 2007/0031691).

Preferably, the thermoplastic polymer film used has, irrespective of the tensile direction considered (in the plane of the film), a tensile modulus (or elastic modulus), denoted by E, which is greater than 500 MPa (especially between 500 and 4000 MPa), more preferably greater than 1000 MPa (especially between 1000 and 4000 MPa), more preferably still greater than 2000 MPa. Values of the modulus E between 2000 and 4000 MPa, in particular between 3000 and 4000 MPa are particularly desirable.

According to another preferred embodiment, irrespective of the tensile direction considered (in the plane of the film), the maximum tensile stress, denoted by σₘₐₓ, of the thermoplastic polymer film is preferably greater than 80 MPa (especially between 80 and 200 MPa), more preferably greater than 100 MPa (especially between 100 and 200 MPa). Values of the stress σₘₐₓ greater than 150 MPa, in particular between 150 and 200 MPa, are particularly desirable.

According to another preferred embodiment, irrespective of the tensile direction considered (in the plane of the film), the yield point, denoted by Yp, of the thermoplastic polymer film is located above 3% elongation, especially between 3% and 15%. Values of Yp above 4%, in particular between 4% and 12%, are particularly desirable.

According to another preferred embodiment, irrespective of the tensile direction considered (in the plane of the film), the thermoplastic polymer film has an elongation at break, denoted by Ar, which is greater than 40% (especially between 40% and 200%), more preferably greater than 50%. Values of Ar between 50% and 200% are particularly desirable.

The abovementioned mechanical properties are well known to a person skilled in the art, they are deduced from force-elongation curves, measured for example according to the standard ASTM D638-02 for strips having a thickness greater than 1 mm, or else according to the standard ASTM D882-09 for thin sheets or films, the thickness of which is at most equal to 1 mm; the above modulus E and stress σₘₐₓ values, expressed in MPa, are calculated with respect to the initial cross section of the test specimen subjected to the tensile test.

The thermoplastic polymer film used is preferably of the thermally stabilized type, i.e. it has undergone, after stretching, one or more heat treatments intended, in a known manner, to limit the thermal contraction (or shrinkage) thereof at high temperature; such heat treatments may especially consist of post-curing or hardening treatments, or combinations of such post-curing or hardening treatments.

Thus, and preferably, the thermoplastic polymer film used has, after 30 min at 150° C., a relative contraction in its length which is less than 5%, preferably less than 3% (measured, unless otherwise indicated, according to ASTM D1204-08).

The melting point of the thermoplastic polymer used is preferably chosen to be above 100° C., more preferably above 150° C., in particular above 200° C.

The thermoplastic polymer is preferably selected from the group consisting of polyamides, polyesters and polyimides, more particularly from the group consisting of polyamides and polyesters. Among the polyamides, mention may especially be made of the polyamides PA-4,6, PA-6, PA-6,6, PA-11 or PA-12. Among the polyesters, mention may be made, for example, of PET (polyethylene terephthalate), PEN (polyethylene naphthalate), PBT (polybutylene terephthalate), PBN (polybutylene naphthalate), PPT (polypropylene terephthalate) and PPN (polypropylene naphthalate).

The thermoplastic polymer is preferably a polyester, more preferably a PET or PEN.

Examples of multiaxially stretched PET thermoplastic polymer films, suitable for the invention, are for example the biaxially stretched PET films sold under the names “Mylar” and “Melinex” (DuPont Teijin Films), or else “Hostaphan” (Mitsubishi Polyester Film).

In the multilayer laminate of the tire according to the invention, the thickness e₁ of the thermoplastic polymer film is preferably between 0.05 and 1 mm, more preferably between 0.1 and 0.7 mm. For example, film thicknesses of 0.20 to 0.60 mm have proved to be perfectly suitable.

The thermoplastic polymer film may comprise additives added to the polymer, especially at the moment when the latter is formed, these additives possibly being, for example, agents for protecting against ageing, plasticizers, fillers such as silica, clays, talc, kaolin or else short fibres; fillers may for example be used to make the surface of the film rough and thus contribute to improving the adhesive uptake thereof and/or the adhesion thereof to the rubber layers with which said film is intended to be in contact.

Each of the two layers of rubber composition, hereinbelow “rubber layer”, which is a constituent of the multilayer laminate, is based on at least one elastomer or rubber.

Preferably, this rubber is a diene rubber, more preferably selected from the group consisting of polybutadienes (BRs), natural rubber (NR), synthetic polyisoprenes (IRs), butadiene copolymers or isoprene copolymers such as for example stirene/butadiene copolymers (SBR5), isoprene/butadiene copolymers (BIR5), isoprene/stirene copolymers (SIRs), isoprene/butadiene/stirene copolymers (SBIRs) and isoprene/isobutylene copolymers (IIRs or butyl rubber), copolymers of dienes and of α-olefins such as for example EPDM rubbers, and mixtures of such elastomers.

According to one particular and preferred embodiment, each rubber layer comprises from 50 to 100 phr of a diene elastomer selected from the group consisting of natural rubber (NR), polybutadienes (BRs), butyl rubbers (IIRs), EPDM rubbers and mixtures of such elastomers.

The above rubber composition may contain a single diene elastomer or several diene elastomers, it being possible for this or these diene elastomer(s) to be used in combination with any type of synthetic elastomer other than a diene elastomer, or even with polymers other than elastomers. The rubber composition may also contain all or some of the additives customarily used in rubber matrices intended for the manufacture of tires, such as, for example, reinforcing fillers such as carbon black or silica, coupling agents, anti-ageing agents, antioxidants, plasticizing agents or extender oils, whether the latter be of aromatic or non-aromatic nature (especially oils that are only very slightly aromatic or are non-aromatic, for example of the napthenic or paraffinic type, of high or preferably low viscosity, MES or TDAE oils), plasticizing resins with a high Tg in excess of 30° C., processing aids that make the compositions easier to process in the uncured state, tackifying resins, anti-reversion agents, methylene acceptors and donors such as for example HMT (hexamethylenetetramine) or H3M (hexamethoxymethylmelamine), reinforcing resins (such as resorcinol or bismaleimide), known adhesion promoter systems of the metal salt type, for example cobalt, nickel or lanthanide salts and a crosslinking or vulcanization system.

Preferably, the system for crosslinking the rubber composition is a vulcanization system, i.e. a system based on sulphur (or on a sulphur donor) and on a primary vulcanization accelerator. Various known secondary vulcanization accelerators or vulcanization activators may be added to this base vulcanization system. The sulphur is used at a preferred content between 0.5 and 10 phr, the primary vulcanization accelerator, for example a sulphenamide, is used at a preferred content between 0.5 and 10 phr. The content of reinforcing filler, for example of carbon black or silica, is preferably greater than 50 phr, especially between 50 and 150 phr.

All carbon blacks, in particular blacks of the HAF, ISAF or SAF type, conventionally used in tires (“tire-grade” blacks) are suitable as carbon blacks. Mention will more particularly be made, among the latter, of the carbon blacks of the 300, 600 or 700 (ASTM) grade (for example, N326, N330, N347, N375, N683 or N772). Precipitated or pyrogenic silicas having a BET surface area of less than 450 m²/g, preferably from 30 to 400 m²/g, are in particular suitable as silicas.

A person skilled in the art will know, in light of the present description, how to adjust the formulation of each rubber layer in order to achieve the desired levels of properties (especially modulus of elasticity), and to adapt this formulation to the specific application envisaged.

Preferably, each rubber layer has, in the crosslinked state, a secant tensile modulus, at 10% elongation, which is between 4 and 25 MPa, more preferably between 4 and 20 MPa. The modulus measurements are carried out in tensile tests, unless otherwise indicated according to the ASTM D 412 standard of 1998 (test specimen “C”): the “true” secant modulus (i.e. that with respect to the actual cross section of the test specimen) at 10% elongation, denoted here by Ms and expressed in MPa is measured in a second elongation (i.e. after an accommodation cycle), under normal temperature and moisture conditions according to the ASTM D 1349 (1999) standard.

In the multilayer laminate of the tire according to the invention, the thickness e₂ of each rubber layer is preferably between 0.05 and 2 mm, more preferably between 0.1 and 1 mm.

The thermoplastic polymer film may be used as it is, i.e. as available commercially, or else re-cut in the form of narrow strips or bands, the width and length of which may vary to a very large extent depending on the targeted applications. Preferably, in the tire of the invention, the thermoplastic polymer film has a width and a length which are respectively greater than 2 mm and 2 cm, preferably respectively greater than 4 mm and 4 cm.

According to one preferred embodiment, the thermoplastic polymer film is provided with an adhesive layer facing each rubber layer with which it is in contact.

In order to adhere the rubber to the thermoplastic polymer film, use could be made of any appropriate adhesive system, for example a simple textile adhesive of the “RFL” (resorcinol-formaldehyde-latex) type comprising at least one diene elastomer such as natural rubber, or any equivalent adhesive known for imparting satisfactory adhesion between rubber and conventional thermoplastic fibres such as polyester or polyamide fibres.

By way of example, the adhesive coating process may essentially comprise the following successive steps: passing into a bath of adhesive, followed by drainage (for example by blowing, grading) to remove the excess adhesive; then drying, for example by passing into an oven (for example for 30 s at 180° C.) and finally heat treatment (for example for 30 s at 230° C.).

Before the above adhesive coating process, it may be advantageous to activate the surface of the film, for example mechanically and/or physically and/or chemically, to improve the adhesive uptake thereof and/or the final adhesion thereof to the rubber. A mechanical treatment could consist, for example, of a prior step of matting or scratching the surface; a physical treatment could consist, for example, of a treatment via radiation such as an electron beam; a chemical treatment could consist, for example, of prior passage into a bath of epoxy resin and/or isocyanate compound.

Since the surface of the thermoplastic polymer film is, as a general rule, particularly smooth, it may also be advantageous to add a thickener to the adhesive used, in order to improve the total uptake of adhesive by the film during the adhesive coating thereof

A person skilled in the art will readily understand that, in the multilayer laminate described above, the connection between the thermoplastic polymer film and each layer of rubber with which it is in contact is definitively provided during the final curing (crosslinking) of the tire of the invention.

FIG. 1 reproduces the stress-elongation curves recorded on a biaxially stretched PET film (“Mylar A” from DuPont Teijin Films, with a thickness of 0.35 mm) which can be used in the sidewalls of tires in accordance with the invention.

The curves denoted by C1, C2 and C3 correspond to a tensile test carried out, respectively, along the main orientation of the film corresponding to the extrusion direction (also known under the name of “MD” direction for “Machine Direction”), along an orientation normal to the MD direction (known under the name of “TD” direction for “Transverse Direction”), and finally along an oblique direction (angle of 45°) relative to the two preceding directions (MD and TD). Mechanical properties such as tensile modulus (E), maximum tensile stress (Gₘₐₓ), yield point Yp and elongation at break (Ar), as indicated in FIG. 1, may be deduced, in a manner well known to a person skilled in the art, from these tensile test curves.

These tensile test curves were recorded and the mechanical properties measured, unless otherwise indicated according to the ASTM D882-09 standard, on test specimens of films in the form of dumbbells having a width of 4 mm and a length of 30 mm (working portion subjected to tensile testing), and having a thickness e₁ equal to that of the thermoplastic polymer film tested, pulled at a rate of 200 mm/min.

On reading FIG. 1, it is observed in particular that the multiaxially stretched thermoplastic polymer film has, which corresponds to another preferred embodiment of the invention, irrespective of the tensile direction considered, the following mechanical properties (deduced from the stress-elongation curves from FIG. 1):
a tensile modulus E greater than 500 MPa;
a maximum tensile stress σₘₐₓ greater than 100 MPa;
a yield point Yp between 5% and 10%;
an elongation at break denoted by Ar greater than 50%.

As one particular example, the multilayer laminate 10 as illustrated in FIG. 2 consists of a biaxially stretched PET film 100, having a thickness e₁ for example equal to around 0.35 mm, sandwiched between two layers 101 of rubber composition, having a thickness e₂ for example equal to around 0.4 mm, the laminate therefore having a total thickness (e₁+2e₂) for example of around 1.15 mm. The rubber composition used here is a conventional tire composition, to typically based on natural rubber, carbon black, a vulcanization system and customary additives. The adhesion between the PET film and each layer of rubber is provided by an RFL adhesive which was deposited, in a known manner, as indicated previously.

As already indicated, the tire of the invention has the essential feature that the inner structure (i.e. the inside) of at least one of its sidewalls is reinforced by a thermoplastic polymer film, multiaxially stretched in its plane, which is located on the outside with respect to the carcass reinforcement and the inflation cavity of the tire.

But the invention also applies to the case where two multiaxially stretched thermoplastic polymer films are used in at least one of its sidewalls, one film located on the outside and the other film located on the inside with respect to the carcass reinforcement and the cavity.

The thermoplastic polymer film, and the multilayer laminate that it forms with its two adjacent rubber layers, may extend essentially over the entire length of sidewall located between the tread and the bead, or over one portion only of the sidewall, for example over around half of the height of the cross section of the tire and the middle of which is found substantially mid-sidewall.

The two rubber layers positioned, in the sidewall, on either side of the thermoplastic polymer film may be, for example, simply constituted on one side (on the outside) by the standard outer part of the sidewall, and on the other side (on the inside) by the rubber layer (or calendering layer) customarily coating the reinforcing threads of the carcass reinforcement, as are described in the introduction of the present document. But at least one of these two rubber layers (or even both) could also be constituted by an additional layer of rubber of different formulation.

The quality of the reinforcement provided to the sidewalls of a tire by the thermoplastic polymer film and the multilayer laminate described above may be evaluated by a perforation test that consists in measuring the resistance to perforation by a given indenter. The principle of this test is well known, described for example in the ASTM F1306-90 standard.

During comparative perforation tests, the following were tested:
on the one hand, a multilayer laminate (10) comprising the biaxially stretched film (100) described above, having a thickness e₁ simply positioned between two rubber layers (101) having a thickness e₂, as illustrated in FIG. 2;
on the other hand, for comparison, a conventional metallic fabric comprising a series of steel multistrand cords (200) positioned parallel to one another, in a plane, according to a lay pitch of around 2.5 mm, this series of cords being coated in rubber (201), as illustrated in FIG. 3; the thickness of rubber at the back of the cords is here equal to e₂, i.e. around 0.4 mm.

These multistrand cords (200) of “6×0.35” or “3×2×0.35” construction are cords that each consist of 3 strands (strands not represented in FIG. 3, for simplification) of 2 threads with a 0.35 mm diameter, assembled together by cabling, in order to form elastic (i.e., high-elongation or HE) metal cords known for reinforcing tires. The total diameter (or envelope diameter) of these cords is around 1.4 mm, so the final metallic fabric has a total thickness of around 2.2 mm.

FIGS. 2 and 3 have been represented on substantially the same scale (scale 1) in order to illustrate the significant difference in thickness that there is between the multilayer laminate used in accordance with the invention (10) and the conventional metallic fabric (20).

In the multilayer laminate of the tire of the invention, the width “L” of the film (100) is preferably identical to the width of the two rubber layers (101) between which it is positioned, as shown schematically in FIG. 2. But the invention also applies to the case where this width L is different, smaller or larger; for example, the thermoplastic polymer film, in this multilayer laminate, could consist of a plurality of narrower strips or bands, for example that are juxtaposed or partially superposed, and oriented in a main direction identical to or different from that of the two rubber layers.

The metal indenter used (illustrated in FIG. 3 under the reference 30) was of cylindrical shape (diameter 4.5 mm±0.05 mm), conical at its end (angle of 30°±2°) and truncated to a diameter of 1 mm. The sample of composite tested (multilayer laminate or control metallic fabric) was attached to a metal support having a thickness of 18 mm which was pierced, in line with the indenter, by a hole having a diameter of 12.7 mm to allow the indenter to pass freely through the perforated sample and its support plate.

Then, in order to characterize the perforation resistance, the force-displacement curve of the above indenter (equipped with sensors connected to the tensile-testing machine), passing through the sample at a rate of 10 cm/min, was recorded.

The table below gives the details of the measurements recorded, the base 100 being used for the control composite: the bending modulus represents the initial gradient of the force-displacement curve; the force at perforation is the maximum force recorded before perforation of the sample by the tip of the indenter; the elongation at perforation is the relative elongation recorded at the moment of perforation.

TABLE

| Composite | Thickness | Bending | Force at | Elongation at |
|---|---|---|---|---|
| tested: | (mm) | modulus | perforation | perforation |
| Control | 2.20 | 100 | 100 | 100 |
| Invention | 1.15 | 93 | 92 | 103 |

On reading the above table, it is observed that the multilayer laminate intended for the sidewalls of the tire according to the invention surprisingly has, despite a thickness that is practically halved relative to the control solution on the one hand, and the absence of reinforcing threads on the other hand, a perforation resistance that is almost equivalent to that of the standard metallic fabric.

In conclusion, the thermoplastic polymer film and the multilayer laminate described above are capable of giving the sidewalls of tires a high resistance to perforation, while combining many advantages, especially a small thickness, low density, low cost and corrosion resistance, compared in particular to conventional metallic fabrics such as those used as protective layers in the sidewalls of these tires.

1. A tire comprising a crown surmounted by a tread, two sidewalls, two beads, each sidewall joining each bead to the crown, a carcass reinforcement anchored in each of the beads and extending into the sidewalls and into the crown, a belt extending into the crown circumferentially and located radially between the carcass reinforcement and the tread, characterized in that at least one of its sidewalls is reinforced by a multiaxially stretched thermoplastic polymer film, positioned between and in contact with two layers of rubber composition, and located on the outside with respect to the carcass reinforcement.

2. The tire according to claim 1, wherein the rubber of each of the two layers of composition is a diene rubber.

3. The tire according to claim 2, wherein the diene rubber is selected from the group consisting of natural rubber, synthetic polyisoprenes, isoprene copolymers, polybutadienes, butadiene copolymers, copolymers of dienes and of α-olefins, and mixtures of such elastomers.

4. The tire according to claim 3, wherein each layer of rubber composition comprises from 50 to 100 phr of a diene elastomer selected from the group consisting of natural rubber, polybutadienes, butyl rubbers, EPDM rubbers and mixtures of such elastomers.

5. The tire according to claim 1, wherein the thermoplastic polymer film has, irrespective of the tensile direction considered, a tensile modulus, denoted by E, which is greater than 500 MPa.

6. The tire according to claim 5, wherein the tensile modulus E is greater than 1000 MPa.

7. The tire according to claim 1, wherein the thermoplastic polymer film has, irrespective of the tensile direction considered, a maximum tensile stress, denoted by σmax, which is greater than 80 MPa.

8. The tire according to claim 7, wherein the stress σₘₐₓ is greater than 100 MPa.

9. The tire according to claim 1, wherein the thermoplastic polymer film has, irrespective of the tensile direction considered, an elongation at break, denoted by Ar, which is greater than 40%.

10. The tire according to claim 1, wherein the thermoplastic polymer film is thermally stabilized.

11. The tire according to claim 1, wherein the thermoplastic polymer film has, after 30 min at 150° C., a relative contraction in length which is less than 5%.

12. The tire according to claim 1, wherein the thermoplastic polymer is a polyester.

13. The tire according to claim 12, wherein the polyester is a polyethylene terephthalate or a polyethylene naphthalate.

14. The tire according to claim 1, wherein the thickness of the thermoplastic polymer film is between 0.05 and 1 mm.

15. The tire according to claim 1, wherein the thickness of each layer of rubber composition is between 0.05 and 2 mm.

16. The tire according to claim 1, wherein the width and the length of the thermoplastic polymer film are respectively greater than 2 mm and 2 cm.

17. The tire according to claim 1, wherein the thermoplastic polymer film is provided with an adhesive layer facing each layer of rubber composition.
